(19) United States
(12) Patent Application Publication
(10) Pub. No.: US 2026/0104316 A1
(43) Pub. Date: Apr. 16, 2026

(54) RECEIVING SYSTEM FOR A DEVICE FOR RECEIVING A UNIT, FIRST RECEIVING UNIT FOR THE RECEIVING SYSTEM, SECOND RECEIVING UNIT FOR THE RECEIVING SYSTEM AND DEVICE FOR RECEIVING A UNIT

(71) Applicant: ZF Friedrichshafen AG, Friedrichshafen (DE)

(72) Inventors: Thomas DWOLINSKI, Passau (DE); Jens EISENBEISS, Fuerstenzell (DE); Roland BÖSL, Neuburg am Inn (DE)

(73) Assignee: ZF Friedrichshafen AG, Friedrichshafen (DE)

(21) Appl. No.: 19/357,775

(22) Filed: Oct. 14, 2025

(30) Foreign Application Priority Data
Oct. 16, 2024 (DE) 10 2024 210 012.9

(51) Int. Cl. G01M 13/025; H02K 15/165

(52) U.S. Cl. CPC G01M 13/025; H02K 15/165

(57) ABSTRACT

A receiving system for receiving a unit device is configured so that in an installed condition the unit is mounted to rotate about a rotation axis on a frame of the device. A second connecting section of a second receiving unit comprises an at least partially circumferential and radially outward-facing contact surface so that in a connected condition it forms an interference fit with an at least partially circumferential and radially inward-facing contact surface of a second connecting section of a first receiving unit in such manner that at least a part of the second connecting section of the first receiving unit is deformed radially outward in such manner that an at least partially circumferential and radially outward-facing contact surface of the second connecting section of the first receiving unit is connected frictionally to at least partially circumferential and radially inward-facing contact surface of the device.

### RELATED APPLICATIONS

This application claims the benefit of and right of priority under 35 U.S.C. § 119 to German Patent Application no. 10 2024 210 012.9, filed on 16 Oct. 2024, the contents of which are incorporated herein by reference in its entirety.

### FIELD OF THE DISCLOSURE

The present invention relates to a receiving system for a device for receiving a unit, in particular a receiving system for a test bench for testing a rotor of an electric drive unit, a first receiving unit for a receiving system, a second receiving unit for a receiving system, and a device for receiving a unit, in particular a test bench for testing a rotor of an electric drive unit.

### BACKGROUND

Receiving systems for devices for receiving a unit, in particular receiving systems for test benches for the testing of rotors of electric drive units, are known from the prior art. In general, in the case of receiving systems for devices for receiving a unit, in particular receiving systems for test benches for the testing of rotors of electric drive units, it is desirable for the unit that is to receive the unit, specifically the rotor when a rotor is to be tested, to be particularly simple to mount in the device, specifically particularly simple to mount on the test bench, and for the unit, specifically the rotor, to be precisely centered in the device, specifically the test bench, when in the fitted condition.

### SUMMARY

It is therefore the purpose of the present invention to provide a device with which the unit for receiving the unit can be mounted in the device particularly simply, and the unit, when in the fitted condition, is centered particularly precisely in the device. In particular, the purpose of the present invention is to provide a test bench in which, for testing a rotor, the rotor can be fitted particularly simply onto the test bench and, when so fitted, the rotor is centered particularly precisely on the test bench.

According to a first aspect of the invention, the objective is achieved by a receiving system with the features disclosed herein. The receiving system is configured for a device designed to receive a unit. Specifically, the receiving system is configured for a test bench for testing a rotor of an electric drive unit. Preferably, when it is being tested with the help of the test bench, the rotor is installed on the test bench. When in an installed condition, the unit is mounted rotatably about a rotation axis on a frame of the device. In particular, during its testing, when it is then preferably in an installed condition, the rotor is fitted on the frame of the test bench so that it can rotate about a rotation axis. The receiving system comprises a first receiving unit and a second receiving unit. The first receiving unit comprises a circumferential first connecting section, a second circumferential connecting section, and a circumferential intermediate section that extends from the first connecting section to the second connecting section. The second receiving unit comprises a circumferential first connecting section, a circumferential second connecting section, and a circumferential intermediate section that extends from the first connecting section to the second connecting section. The second connecting section of the first receiving unit has an at least partially circumferential contact surface that faces radially outward, which is so designed that in use it forms a clearance fit with an at least partially circumferential contact surface of a section of the device, specifically the test bench, that faces inward. The second connecting section of the second receiving unit comprises an at least partially circumferential and radially outward-facing contact surface of the second connecting section of the first receiving unit, forming in that way, when in a connected condition, an interference fit such that at least part of the second connecting section of the first receiving unit is radially deformed outward in such manner that the at least partially circumferential and radially outward-facing contact surface of the second connecting section of the first receiving unit and the at least partially circumferential and radially inward-facing contact surface of the part of the device, specifically the test bench, are connected with one another by friction force.

As already described, the device is configured for receiving the unit. In an installed condition the unit is mounted on the frame of the device and can rotate about a rotation axis. Preferably the device is a test bench for testing a rotor of an electric drive unit. Thus, in particular, the receiving system is configured for a test bench for testing a rotor of an electric drive unit. Accordingly, the rotor constitutes a preferred example of the already-mentioned unit. Preferably, while being tested the rotor is mounted so that it can rotate on the frame about its rotation axis. Preferably, while testing the rotor of the electric drive unit, the rotor is repeatedly displaced in rotation about the rotation axis and accelerated to a maximum rotation speed and then braked again, the latter of which can also be called deceleration. During this, the rotor is preferably exposed to various operating temperatures. The testing of the rotor can preferably last for several hours or even several days. The test bench can also be called a Speed Change Tester (SCT). Alternatively preferred, the device is a test bench for testing a rotor of a turbine. The features, technical effects and/or advantages described in connection with the test bench for testing a rotor of an electric drive unit also apply, at least in an analogous manner, to a test bench for testing a turbine rotor, so no corresponding descriptions will be repeated at this point. Furthermore, the features, technical effects and/or advantages described in connection with the rotor of the electric drive unit apply, at least in an analogous manner, to the rotor of a turbine so that here, too, no corresponding descriptions will be repeated. Alternatively preferably, the device is a machine tool, and the unit is a tool that can be held by the machine tool. The features, technical effects, and/or advantages described in connection with the test bench for the testing of a rotor of an electric drive unit, or a test bench for testing a turbine rotor, apply at least analogously to the machine tool, so that in this case as well no corresponding descriptions will be repeated. Moreover, the features, technical effects, and/or advantages described in connection with the rotor of an electric drive unit and the turbine rotor also apply at least analogously to the tool that can be held by the machine tool, so that once again no corresponding descriptions will be repeated.

As also already described, the receiving system comprises the first receiving unit and the second receiving unit. Since the receiving system comprises the first receiving unit and the second receiving unit, it is preferably ensured that with the help of the first receiving unit and with the help of the second receiving unit the unit can be attached rotatably on the frame of the device, specifically ensured that the rotor can be attached rotatably on the frame of the device.

Also, as already described, the first receiving unit comprises the circumferential first connecting section, the circumferential second connecting section, and the circumferential intermediate section that extends from the first connecting section to the second connecting section. Since the circumferential intermediate section of the first receiving unit extends from the first connecting section to the second connecting section, the intermediate section can deform elastically in such manner that the first connecting section and/or the second connecting section, when the intermediate section is in an elastically deformed condition in which the intermediate section is elastically deformed, is/are arranged in the axial direction offset relative to the case when the intermediate section is in an elastically undeformed condition in which the intermediate is not elastically deformed. The elastic deformation of the intermediate section occurs in such manner that the first connecting section and/or the second connecting section can adopt a different position due to the elastic deformation of the intermediate section in the axial direction, ensuring that an axial length variation of the unit, in particular the rotor, can be compensated with the help of the elastic deformation of the intermediate section, in the sense that the unit, in particular the rotor, is mounted in a precisely centered manner even if its axial length has changed. In particular, in that way, precisely centered mounting of the unit, specifically the rotor, is even ensured after temperature changes, for example of 200° C. Thanks to the possibility of deforming the intermediate section elastically, the receiving system can also be called an elastic receiving system or an elastic receiver, since during operation, i.e., when the unit is in an installed condition, in particular therefore during the testing of the rotor, thermal loads and/or length expansions can be compensated elastically, Preferably, the extension of the intermediate section in the axial direction in the elastically undeformed condition, i.e., the thickness of the intermediate section, can be adapted correspondingly in accordance with the unit to be received, in particular in accordance with the temperature range to be examined and depending on the rotor being tested, so that the elastic deformability of the intermediate section matches the corresponding length variation of the unit, specifically the rotor, in the axial direction. The extension of the intermediate section in the axial direction in the elastically undeformed condition, i.e., the thickness of the intermediate section, is preferably less than both the extension of the first connecting section of the first receiving unit in the axial direction and also preferably less than the extension of the second connecting section of the first receiving unit in the axial direction, so that preferably both a robust mechanical connection preferably between the first receiving unit and the unit, specifically the rotor, and preferably a mechanically robust connection between the first receiving unit and the part of the device, specifically the test bench, is ensured and also a sufficient elastic deformability of the intermediate section is ensured, and this is ensured while using little material, so that the receiving system is constructed compactly and in a particularly material-saving manner. The intermediate section preferably extends around the rotation axis and thus preferably extends along a plane arranged perpendicularly to the rotation axis. Since the intermediate section extends around the rotation axis and is arranged along a plane perpendicular to the rotation axis, it is ensured that the first receiving unit has high radial rigidity. In this case the rigidity of the first receiving unit in the radial direction is preferably uniform. The high radial rigidity of the first receiving unit, and in particular the uniform rigidity of the first receiving unit in the radial direction, has a particularly positive effect on the movement of the unit, specifically the rotor, which is consequently particularly uniform. Furthermore, the high radial rigidity of the first receiving unit, and in particular the uniform rigidity of the first receiving unit in the radial direction, can substantially increase the bend-critical rotation speed. In this context the bend-critical rotation speed is understood to mean a rotation speed at which the forces of a defined imbalance excites the unit, specifically the rotor, and/or the device, specifically the test bench, into resonance vibrations.

As also already described, the second receiving unit comprises the circumferential first connecting section, the circumferential second connecting section, and the circumferential intermediate section that extends from the first connecting section to the second connecting section. The intermediate section of the second receiving unit is preferably constructed similarly to the intermediate section of the first receiving unit and the features, technical effects and/or advantages described in connection with the first receiving unit apply at least analogously to the intermediate section of the second receiving unit, so that no corresponding repetition of the description will be given at this point.

As also already described, the second connecting section of the first receiving unit comprises the at least partially circumferential and radially outward-facing contact surface, which is designed such that in the installed condition it forms a clearance fit with the at least partially circumferential and radially inward-facing contact surface of the part of the device, specifically the test bench. Since the second connecting section of the first receiving unit comprises the at least partially circumferential and radially outward-facing contact surface, which is designed such that in the installed condition it forms a clearance fit with the at least partially circumferential and radially inward-facing contact surface of the section of the device, specifically the test bench, it is ensured that the first receiving unit can be mounted particularly simply on the part of the device, specifically the test bench, whereby the unit, specifically the rotor, can also be installed particularly simply in the device with the help of the first receiving unit and with the help of the second receiving unit, in order to receive the unit, specifically the rotor, and for that reason the receiving system can also be regarded as particularly assembly-friendly.

As also already described, the second connecting section of the second receiving unit comprises the at least partially circumferential and radially outward-facing contact surface, which is designed such that in the connected condition with the at least partially circumferential and radially inward-facing contact surface of the second connecting section of the first unit, it forms an interference fit in such manner that at least part of the second connecting section of the first receiving unit is deformed radially outward so that the at least partially circumferential and radially outward-facing contact surface of the second connecting section of the first receiving unit and the at least partially circumferential and radially inward-facing contact surface of the part of the device, specifically the test bench, are connected to one another by friction force. Since the second connecting section of the second receiving unit comprises the at least partially circumferential and radially outward-facing contact surface, which is designed such that that in the connected condition it forms an interference fit with the at least partially circumferential and inward-facing contact surface of the first receiving unit in such manner that the at least one part of the second connecting section of the first receiving unit is deformed radially outward so that the at least partially circumferential and radially outward-facing contact surface of the second connecting section of the first receiving unit and the at least partially circumferential and radially inward-facing contact surface of the part of the device, specifically the test bench, are connected with one another by friction force, it is ensured that that the first receiving unit, with the help of the second receiving unit, can be particularly precisely centered in particular relative to the rotation axis, which can also be referred to as an exact centering of the first receiving unit. In that with the help of the second receiving unit the first receiving unit can be centered particularly precisely, the first receiving unit provides a particularly precisely centered component with which a section of the unit, specifically the rotor, can be connected directly or indirectly via a further component such as the second receiving unit, or more than one further component, so that the unit, specifically the rotor, is centered particularly precisely. Thus, the unit, specifically the rotor, can be tested while particularly precisely centered. Hence, with the help of the receiving system it is ensured that alignment faults can be avoided or at least kept particularly small.

In summary, it can thus be established that with the help of the present invention the unit for receiving the unit can be fitted particularly simply in the device and that in the fitted condition it is particularly precisely centered in the device. Specifically, with the help of the present invention the rotor to be tested can be fitted particularly simply onto the test bench and in the fitted condition the rotor is particularly precisely centered in the test bench.

In an embodiment, the first connecting section of the first receiving unit comprises an at least partially circumferential and radially inward-facing contact surface, which is designed such that in a connected condition it can be connected by friction force with an at least partially circumferential and radially outward-facing contact surface of the unit, specifically the rotor. Since the first connecting section of the first receiving unit comprises the at least partially circumferential and radially inward-facing contact surface, which is designed such that in the connected condition it can be connected by friction force to the at least partially circumferential and radially outward-facing contact surface of the unit, specifically the rotor, it is ensured that in the connected condition the first receiving unit and the unit, specifically the rotor, are connected with one another and torques can be transmitted between the first receiving unit and the unit, specifically the rotor. Preferably, the frictional connection is ensured with the help of a transverse interference fit. The transverse interference fit is preferably made such that before the friction-force connection of the contact surface of the first connecting section of the first receiving unit and the contact surface of the unit, specifically the rotor, at least part of the first receiving unit is heated, whereby the contact surface of the first connecting section of the first receiving unit expands radially outward, so that for the connection of the contact surface of the first connecting section of the first receiving unit and the contact surface of the unit, specifically the rotor, no force or only a much smaller force has to be applied than in a situation in which the first receiving unit has not been heated before the frictional connection of the contact surface of the first connecting section of the first receiving unit and the contact surface of the unit, specifically the rotor. Preferably, the contact surface of the first connecting section of the first receiving unit and the contact surface of the unit, specifically the rotor, are now connected with one another in the axial direction and the heating of at least part of the first receiving unit is discontinued, so that when the temperature subsequently equalizes, pressure is produced and the interference fit is created. During this process both the surface roughness of the contact surface of the first connecting section of the first receiving unit and the surface roughness of the contact surface of the unit, specifically the rotor, are largely maintained, whereby a particularly robust mechanical seating is produced.

In an embodiment, the first connecting section of the second receiving unit comprises an at least partially circumferential and radially inward-facing contact surface, which is designed such that in a connected condition it forms a clearance fit with an at least partially circumferential and radially outward-facing contact surface of the unit, specifically the rotor. Since the first connecting section of the second receiving unit comprises the partially circumferential and radially inward-facing contact surface, which is designed such that in the connected condition it forms a clearance fit with the at least partially circumferential and radially outward-facing contact surface of the unit, specifically the rotor, it is ensured that a movement of the second receiving unit in the axial direction relative to the unit, specifically the rotor, is possible particularly simply. Furthermore, since a clearance fit is provided between the contact surface of the first connecting section of the second receiving unit and the contact surface of the unit, specifically the rotor, it is ensured that the first connecting section of the second receiving unit can be arranged radially outside a part of the unit, specifically the rotor, so that when this is the case and if the first receiving unit should fail owing to an overload, a position of the unit, specifically the rotor, is limited outward in the radial direction by the second receiving unit. Thus, if at least part of the first receiving unit fails mechanically and therefore the holding of the unit, in particular the testing of the rotor, has to be discontinued, the unit, specifically the rotor, is caught by the second receiving unit and can be reliably braked or run down. This is in particular improved if the second receiving unit is preferably moved close to the unit, specifically the rotor.

In an embodiment, the first connecting section of the first receiving unit comprises an at least partially circumferential groove opening radially outward. Since the first connecting section of the first receiving unit has the at least partially circumferential and radially outward-opening groove, it is ensured that an extraction tool can engage radially inward in the groove and can pull the first receiving unit in the axial direction away from the unit, specifically the rotor.

In an embodiment, when in a connected condition, the first connecting section of the first receiving unit is connected with a part of the device, specifically the test bench, which is positioned and able to rotate around the rotation axis. Since in the connected condition the first connecting section of the first receiving unit is connected to the part of the device, specifically the test bench, which is positioned and able to rotate around the rotation axis, it is ensured that the unit, specifically the rotor, can with the help of the first receiving unit be mounted and able to rotate on the frame of the device, specifically the test bench, by virtue of the rotatably fitted part of the device, specifically the test bench.

In an embodiment, the first connecting section of the second receiving unit comprises an at least partially circumferential and radially inward-facing contact surface, which is designed such that in a connected condition it can be connected by friction force to an at least partially circumferential and radially outward-facing contact surface of the unit, specifically the rotor. Since the first connecting section of the second receiving unit comprises the at least partially circumferential and radially inward-facing contact surface, which is designed such that in the connected condition it can be frictionally connected to the at least partially circumferential and radially outward-facing contact surface of the unit, specifically the rotor, it is ensured that in the connected condition torques can be transmitted between the second receiving unit and the unit, specifically the rotor.

In an embodiment, the at least partially circumferential and radially inward-facing contact surface of the part of the device, specifically the test bench, with which, in the installed condition, the at least partially circumferential and radially outward-facing contact surface of the second connecting section of the first receiving unit forms the clearance fit, comprises a contact surface of the part of the device, specifically the test bench, which is mounted rotatably about the rotation axis, or the receiving system has a centering ring which comprises an at least partially circumferential and inward-facing contact surface which, in the installed condition, forms the clearance fit with the at least partially circumferential and radially outward-facing contact surface of the second connecting section of the first receiving unit.

For the case when the at least partially circumferential and radially inward-facing contact surface of the device, specifically the test bench, with which the at least partially circumferential and radially outward-facing contact surface of the second connecting section of the first receiving unit which forms the clearance fit in the installed condition, is a contact surface of a part of the device, specifically the test bench, which is mounted rotatably about the rotation axis, this ensures that by means of the second receiving unit the clearance fit can be changed to a friction-force connection, so that torques can be transmitted between the first receiving unit and the part of the device, specifically the test bench, that is mounted rotatably about the rotation axis. For the case when the receiving system comprises the centering ring, which comprises the at least partially circumferential and radially inward-facing contact surface, with which, in the installed condition, the at least partially circumferential and radially outward-facing contact surface of the second connecting section of the first receiving unit forms the clearance fit, this ensures that the centering of the first receiving unit can be further improved.

According to a second aspect of the invention, the stated objective is achieved by a first receiving unit having the features disclosed herein. The first receiving unit has a first circumferential connecting section, a second circumferential connecting section, and a circumferential intermediate section that extends from the first connecting section to the second connecting section. The features, technical effects, and/or advantages described in connection with the receiving system according to the first aspect of the invention also apply, at least in an analogous manner, to the first receiving unit according to the second aspect of the invention, so that at this point there will be no corresponding repetition.

According to a third aspect of the invention, the stated objective is achieved with a second receiving unit having the features disclosed herein. The second receiving unit comprises a first circumferential connecting section, a second circumferential connecting section, and a circumferential intermediate section that extends from the first connecting section to the second connecting section. The features, technical effects and/or advantages described in connection with the receiving system according to the first aspect of the invention and the features, technical effects, and/or advantages described in connection with the receiving system according to the second aspect of the invention also apply at least in an analogous manner to the second receiving unit according to the third aspect of the invention, so that no corresponding repetition will be made at this point.

According to a fourth aspect of the invention, the stated objective is achieved by a device with the features disclosed herein. Preferably, the device is a test bench. The device is configured so as to receive a unit. Preferably, the test bench is configured so as to test a rotor of an electric drive unit. Alternatively preferably, the test bench is configured to test a rotor of a turbine. In an installed condition, the unit is mounted to rotate about a rotation axis on a frame of the device. Preferably, during testing the rotor is mounted to rotate about a rotation axis on the frame of the test bench. The device comprises a receiving system according to the first aspect of the invention. Preferably, the test bench comprises a receiving system according to the first aspect of the invention. The features, technical effects, and/or advantages described in connection with the receiving unit according to the first aspect of the invention, the features, technical effects, and/or advantages described in connection with the receiving unit according to the second aspect of the invention and the features, technical effects, and/or advantages described in connection with the receiving unit according to the third aspect of the invention also apply, at least in an analogous manner, to the device, specifically the test bench, according to the fourth aspect of the invention, so that no corresponding repetition will be made at this point.

Further features, advantages, and application possibilities of the present invention emerge from the following description of example embodiments and from the figures. All the features described and/or pictorially illustrated, in their own right and in any desired combination, constitute the object of the invention, also independently of their composition in the individual claims or their back-references. In the figures, the same indexes also denote the same or similar objects.

### BRIEF DESCRIPTION OF THE DRAWINGS

FIG. 1 shows a schematic representation of a first embodiment of a test bench according to the invention,

FIGS. 2 and 3 show, respectively, schematic representations of corresponding sections of the first embodiment of the test bench according to the invention shown in FIG. 1,

FIGS. 4 and 5show, respectively, schematic representations of a second embodiment of the test bench according to the invention,

FIG. 6 shows a schematic representation of a section, marked with the letter “A” in FIG. 5, of the second embodiment of the test bench according to the invention,

FIGS. 7 to 12 show, respectively, schematic representations of corresponding sections of the second embodiment of the test bench according to the invention,

FIG. 13 shows a schematic representation of a section of a third embodiment of the test bench according to the invention, and

FIGS. 14 and 15 show, respectively, schematic representations of a corresponding section of a fourth embodiment of the test bench according to the invention.

### DETAILED DESCRIPTION

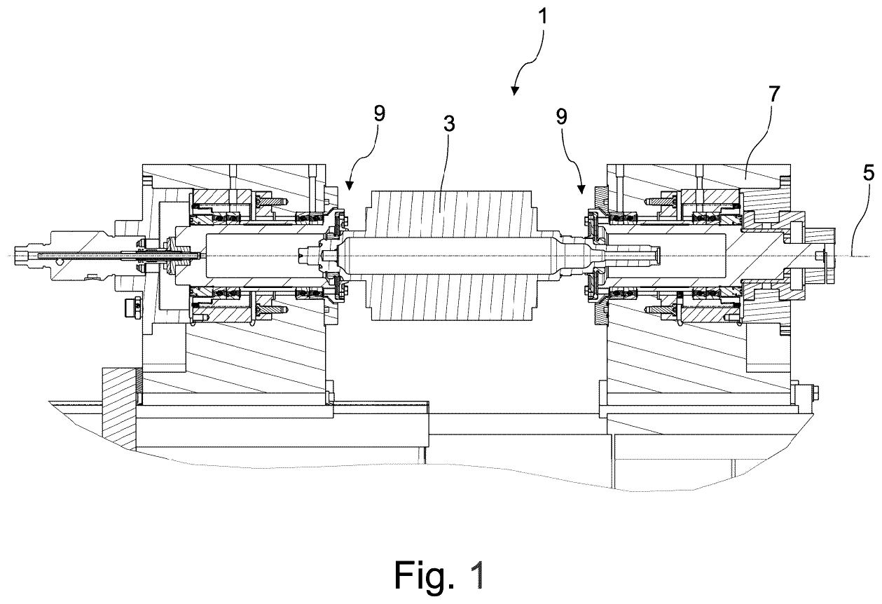

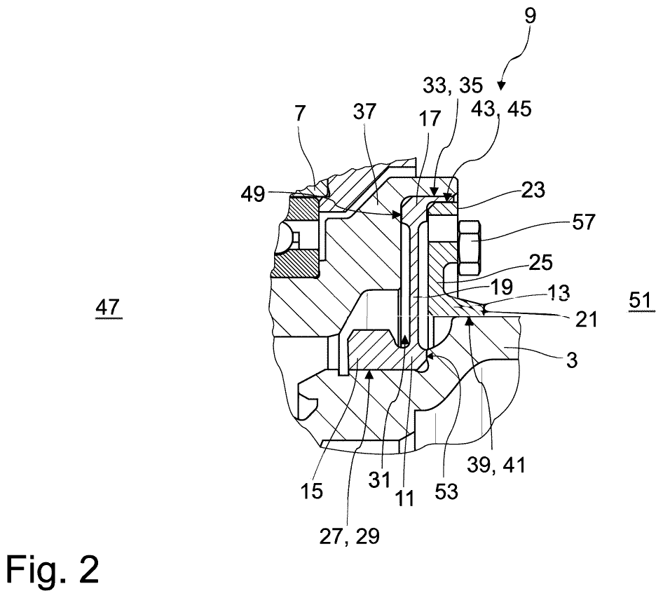

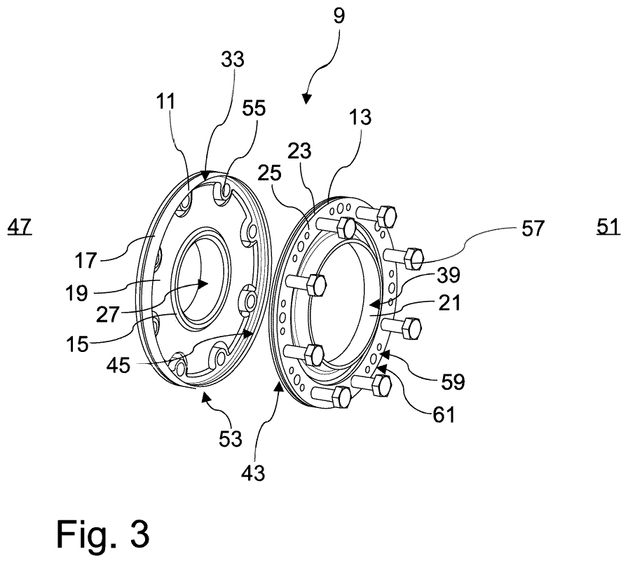

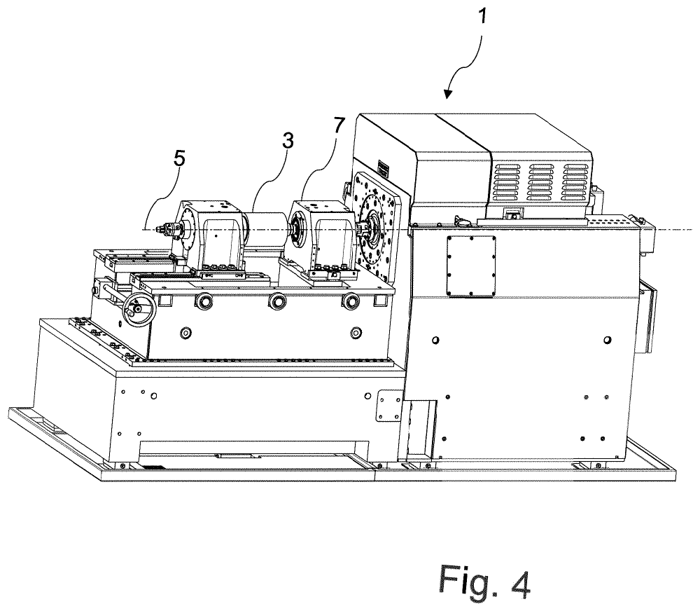

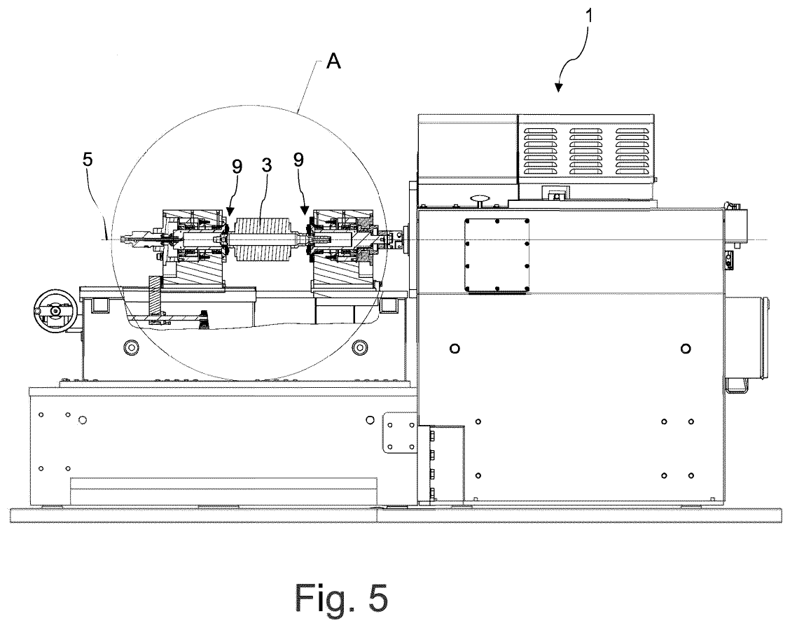

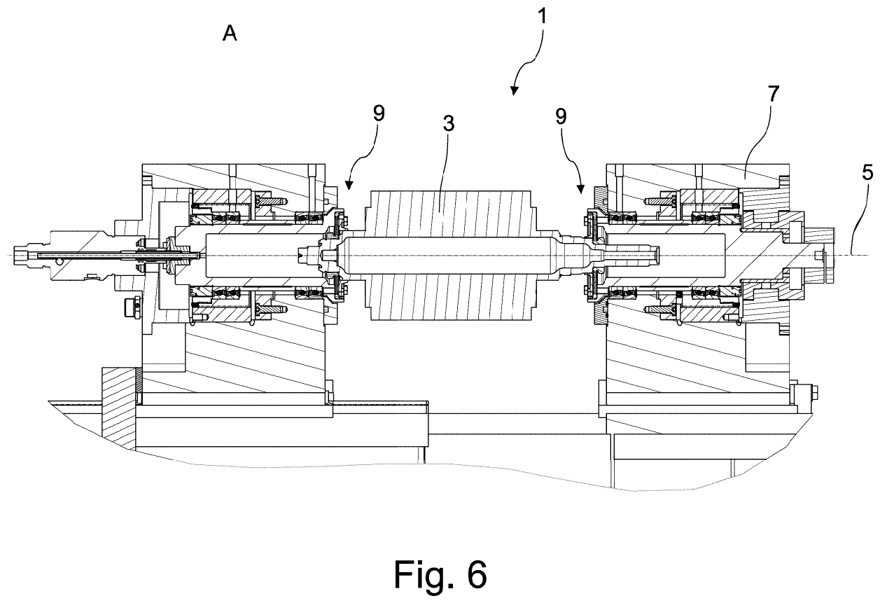

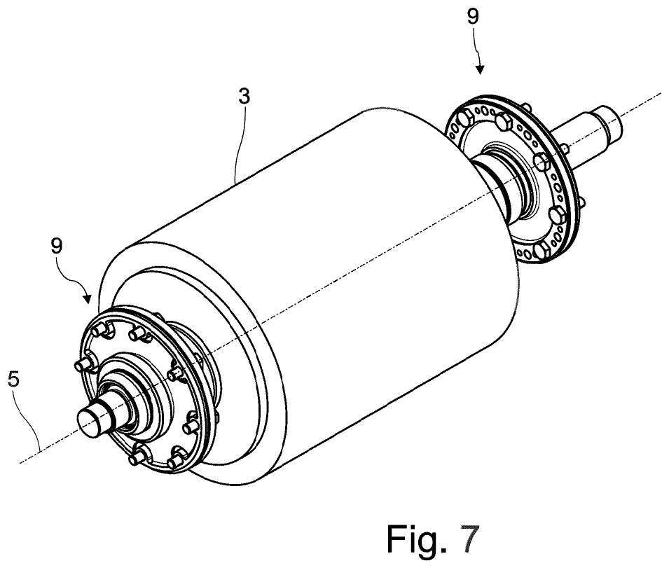

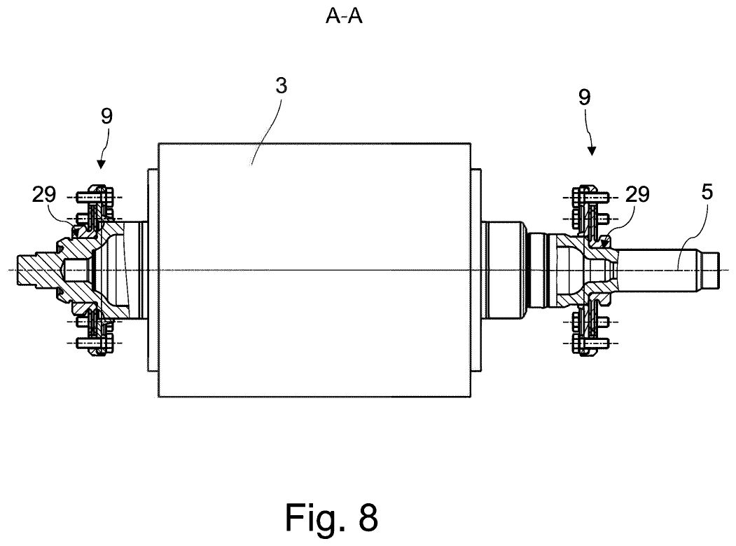

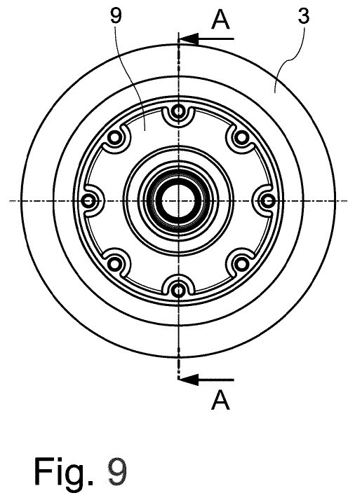

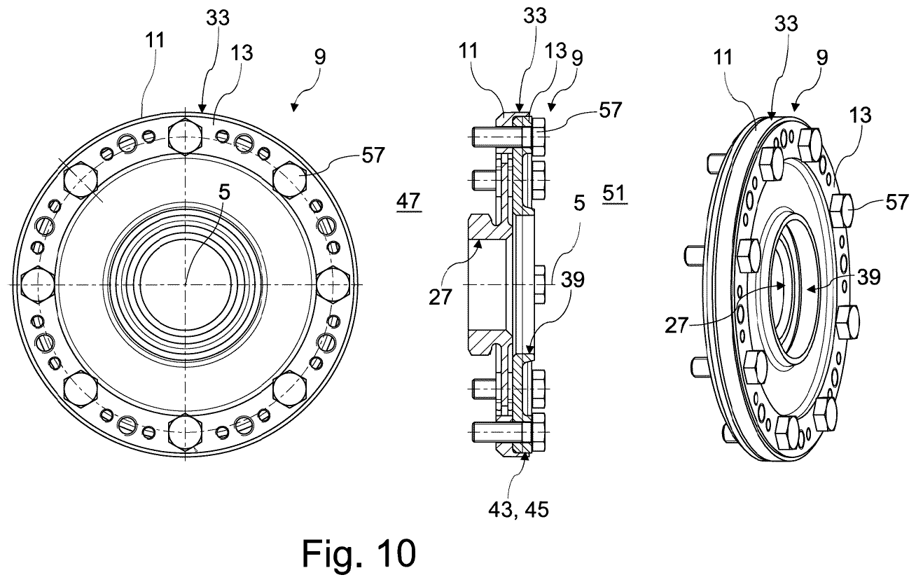

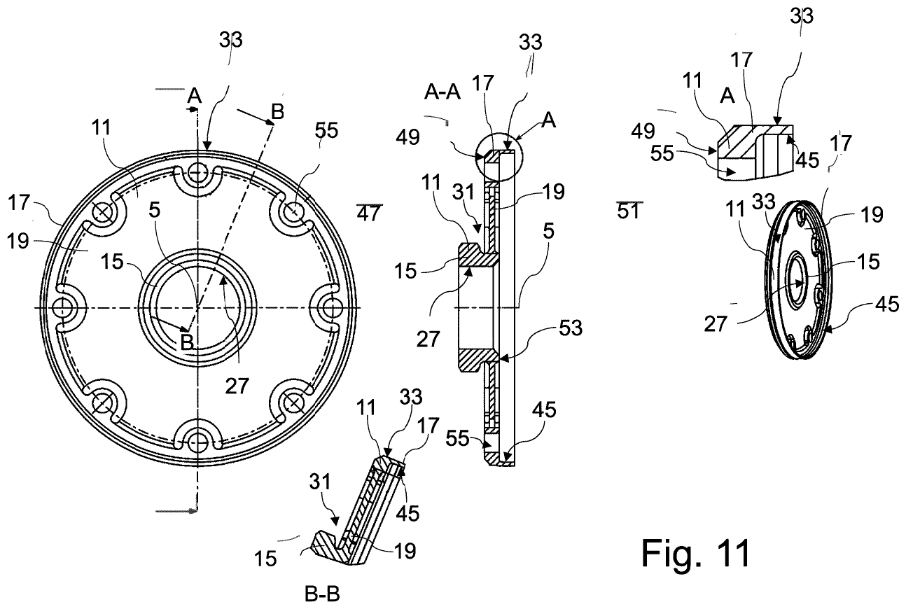

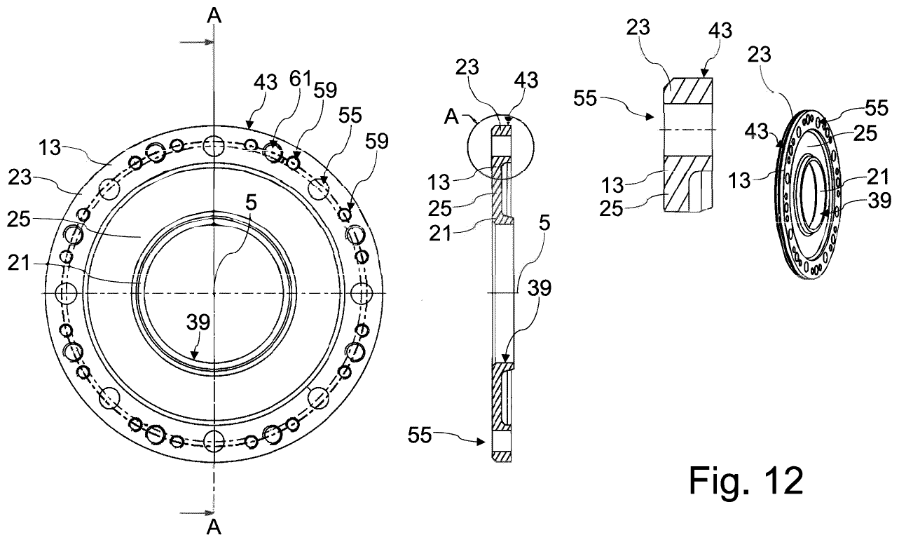

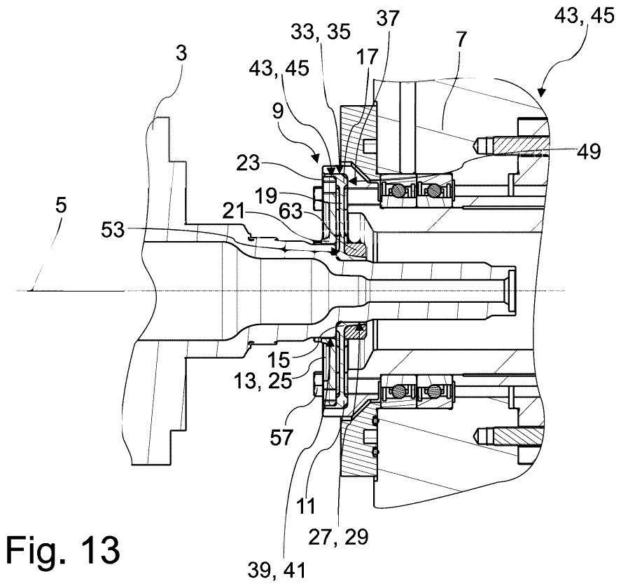

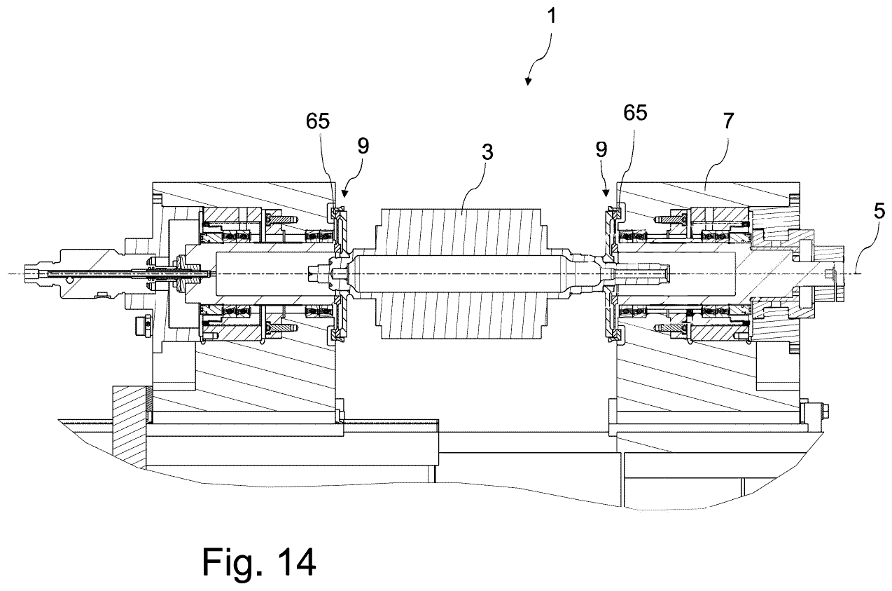

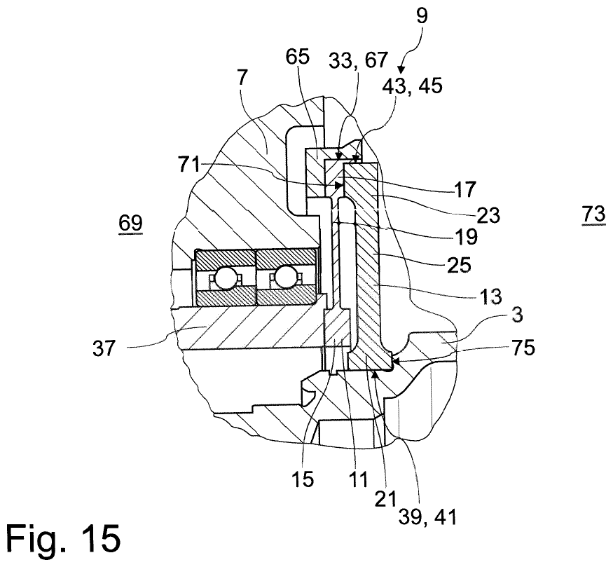

FIG. 1 shows a schematic representation of a first embodiment of a test bench 1 according to the invention. FIGS. 2 and 3 show, respectively, schematic representations of a corresponding section of the first embodiment of the test bench 1 illustrated schematically in FIG. 1. FIGS. 4 and 5 show, respectively, schematic representations of a second embodiment of the test bench 1 according to the invention. FIG. 6 shows a schematic representation of a section of the second embodiment of the test bench 1 according to the invention, marked in FIG. 5 with the letter “A”. FIGS. 7 to 12 show, respectively, schematic representations of corresponding sections of the second embodiment of the test bench 1 according to the invention. FIG. 13 shows a schematic representation of a section of a third embodiment of the test bench 1 according to the invention, and FIGS. 14 and 15 show, respectively, schematic representations of a corresponding section of a fourth embodiment of the test bench 1 according to the invention.

The test bench 1 is designed for testing a rotor 3 of an electric drive unit. While being tested, the rotor 3 is mounted to rotate about a rotation axis 5 on a frame 7 of the test bench 1. While the rotor 3 of the electric drive unit is being tested, the rotor 3 is repeatedly moved in rotation about the rotation axis 5, and accelerated to a maximum rotation speed and then braked again, which can also be called deceleration. During this, the rotor 3 is exposed to various operating temperatures. The testing of the rotor 3 can last several hours or even several days. The test bench 1 can also be called a Speed Change Tester (SCT). The test bench 1 comprises a receiving system 9. Thus, the receiving system 9 is configured for the test bench 1. The receiving system 9 comprises a first receiving unit 11 and a second receiving unit 13. The first receiving unit 11 comprises a first circumferential connecting section 15, a second circumferential connecting section 17 and a circumferential intermediate section 19 that extends from the first receiving section 15 to the second connecting section 17. The second receiving unit 13 comprises a first circumferential connecting section 21, a second circumferential connecting section 23 and a circumferential intermediate section 25 that extends from the first connecting section 21 to the second connecting section 23.

The test bench 1 constitutes an embodiment according to the invention for receiving a unit. Moreover, a test bench for testing a rotor of a turbine constitutes an embodiment of the device according to the invention for receiving a unit. Furthermore, a machine tool constitutes an embodiment of the device according to the invention for receiving a unit, such that in that embodiment the unit is a tool which can be held by the machine tool. The features, technical effects, and/or advantages described in connection with the test bench 1 for testing a rotor of an electric drive unit also apply at least in an analogous manner to the test bench for testing a rotor of a turbine, so that no corresponding reiteration will be made at this point. Furthermore, the features, technical effects and/or advantages described in connection with the rotor 3 of the electric drive unit also apply at least in an analogous manner to the rotor of the turbine, so that here too no corresponding reiteration will be made. The features, technical effects, and/or advantages described in connection with the test bench for testing a rotor of an electric drive unit and the features, technical effects, and/or advantages described in connection with the test bench for testing a rotor of a turbine also apply at least in an analogous manner to the machine tool, so that here again no corresponding reiteration will be made. Moreover, the features, technical effects, and/or advantages described in connection with the rotor 3 of the electric drive unit and the features, technical effects and/or advantages described in connection with the rotor of the turbine also apply at least in an analogous manner to the tool that can be held by the machine tool, so that no corresponding reiteration will be made at this point.

In the first embodiment of the test bench 1 according to the invention, and in the second embodiment of the test bench 1 according to the invention, the first connecting section 15 of the first receiving unit 11 has an at least partially circumferential and radially inward-facing contact surface 27. The contact surface 27 is designed such that in a connected condition it can be connected by friction force to an at least partially circumferential and outward-facing contact surface 29 of the rotor 3. Both in the first embodiment of the test bench 1 according to the invention and in the second embodiment of the test bench 1 according to the invention, the frictional connection is ensured with the help of an interference fit. The interference fit is made such that before the frictional connection of the contact surface 27 of the first connecting section 15 of the first receiving unit 11 and the contact surface 29 of the rotor 3, the first receiving unit 11 is heated, at least in part, whereby the contact surface 27 of the first connecting section 15 of the first receiving unit 11 expands radially outward so that for connecting the contact surface 27 of the first connecting section 15 of the first receiving unit 11 and the contact surface 29 of the rotor, in the axial direction no force, or only a much smaller force has to be applied than would be the case in the situation in which, before the frictional connection of the contact surface 27 of the first connecting section 15 of the first receiving unit 11 the first receiving unit 11 is not heated. The contact surface 27 of the first connecting section 15 of the first receiving unit 11 and the contact surface 29 of the rotor 3 are now connected with one another in the axial direction and the at least partial heating of the first receiving unit 11 is discontinued, so that during the subsequent temperature equalization the pressure increases so that the interference fit is formed. During the process both the surface roughness of the contact surface 27 of the first connecting section 15 of the first receiving unit 11 and also the surface roughness of the contact surface 29 of the rotor 3 are to a large extent maintained, whereby a mechanically particularly robust seating is produced.

In the first embodiment of the test bench 1 according to the invention, and in the second embodiment of the test bench 1 according to the invention, the contact surface 27 of the first connecting section 15 of the first receiving unit 11 extends completely all round. Since the contact surface 27 of the first connecting section 15 of the first receiving unit 11 is a circumferential surface, particularly in combination with a completely circumferential contact surface 29 of the rotor 3, a particularly robust connection is produced between the first receiving unit 11 and the rotor 3. When the rotor 3 is fitted into the test bench 1 in order to test the rotor 3, the first receiving unit 11 and the rotor 3 are in a connected condition in which the contact surface 27 of the first connecting section 15 of the first receiving unit 11 and the contact surface 29 of the rotor 3 are held together by friction force. The frictional connection between the contact surface 27 of the first connecting section 15 of the first receiving unit 11 and the contact surface 29 of the rotor 3 ensures a transfer of torque from the rotor 3 to the first receiving unit 11 and/or from the first receiving unit 11 to the rotor 3. The frictional connection between the contact surface 27 of the first connecting section 15 of the first receiving unit 11 and the contact surface 29 of the rotor 3 pertains to a friction-force lock between the two components, opposing a relative rotation movement about the rotation axis 5.

In the first embodiment of the test bench 1 according to the invention and in the second embodiment of the test bench 1 according to the invention, the first connecting section 15 of the first receiving unit 11 has an at least partially circumferential groove 31 which opens radially outward. In that the groove 31 is at least partially circumferential and open outward, an extraction tool can engage radially inward in the groove 31 and pull the first receiving unit 11 in the axial direction away from the rotor 3. Preferably, the first receiving unit 11 is first heated in part so that the force to be applied for pulling the first receiving unit 11 in the axial direction away from the rotor 3 is minimized. In the first embodiment of the test bench 1 according to the invention and in the second embodiment of the test bench 1 according to the invention, the groove 31 is made all the way round. Since the groove 31 is made all the way round, the extraction tool can engage radially inward in the groove 31 all the way round so that particularly large forces can be applied for pulling the first receiving unit 11 clear of the rotor 3.

In the first embodiment of the test bench 1 according to the invention and in the second embodiment of the test bench 1 according to the invention, the second connecting section 17 of the first receiving unit 11 has an at least partially circumferential and radially outward-facing contact surface 33. The contact surface 33 is designed such that in an installed condition it forms a clearance fit with an at least partially circumferential and radially inward-facing contact surface 35 of a part 37 of the test bench 1 that is mounted to rotate about the rotation axis 5. Since there is a clearance fir between the contact surface 33 of the second connecting section 17 of the first receiving unit 11 and the contact surface 35 of the part 37 of the test bench 1, it is ensured that the first receiving unit 11 can be fitted onto the part 37 of the test bench 1 particularly simply, and for that reason the receiving system 9 can also be regarded as particularly assembly-friendly.

In the first embodiment of the test bench 1 according to the invention and in the second embodiment of the test bench 1 according to the invention, the contact surface 33 of the second connecting section 17 of the first receiving unit 11 is made completely circumferential. Since the contact surface 33 of the second connecting section 17 of the first receiving unit 11 is made completely circumferential, particularly in combination with a completely circumferential contact surface 35 of the part 37 of the test bench 1, a mechanically particularly robust connection between the first receiving unit 11 and the part 37 of the test bench 1 is formed, and later more will be said about this connection between the first receiving unit 11 and the part 37 of the test bench 1. In order to position the rotor 3 on the test bench 1 for the testing of the rotor 3, first the first receiving unit 11 and the rotor 3 are brought to the already-described connected condition in which the contact surface 27 of the first connecting section 15 of the first receiving unit 11 is connected to the contact surface 28 of the rotor 3 by friction force. Next, the rotor 3 together with the first receiving unit 11 are placed in the part 37 of the test bench 1 in such manner that the first receiving unit 11 is in an inserted condition in which the contact surface 33 forms a clearance fit with the at least partially circumferential and radially inward-facing contact surface 35 of the part 37 of the test bench 1 that can rotate about the rotation axis 5. By virtue of the clearance fit the first receiving unit 11 can be brought particularly simply to the inserted condition. Preferably, the second connecting section 17 of the first receiving unit 11 is in an undeformed condition, in particular in an elastically undeformed condition. The clearance fit between the contact surface 33 of the second connecting section 17 of the first receiving unit 11 and the contact surface 35 of the part 37 of the test bench 1 refers to a clearance fit between those two components, so that a relative rotation movement around the rotation axis 5 can take place thanks to the clearance fit.

In the first embodiment of the test bench 1 according to the invention and in the second embodiment of the test bench 1 according to the invention, the first connecting section 21 of the second receiving unit 13 comprises an at least partially circumferential and radially inward-facing contact surface 39. The contact surface 39 is designed such that in a connected condition it forms a clearance fit with an at least partially circumferential and outward-facing contact surface 41 of the rotor 3. The contact surface 29 of the rotor 3 already mentioned earlier can also be called the first contact surface of the rotor 3 and the contact surface 41 of the rotor 3 mentioned here can also be called the second contact surface of the rotor 3. Since there is a clearance fit between the contact surface 39 of the first connecting section 21 of the second receiving unit 13 and the contact surface 41 of the rotor 3, it is ensured that a movement of the second receiving unit 13 in the axial direction relative to the rotor 3 is possible particularly simply. Moreover, since there is a clearance fit between the contact surface 39 of the first connecting section 21 of the second receiving unit 13 and the contact surface 41 of the rotor 3, it is ensured that the first connecting section 21 of the second receiving unit 13 is arranged radially outside a section of the rotor 3, so that if owing to overloading the first receiving unit 11 should fail mechanically, then owing to the second receiving unit 13 a position of the rotor 3 is restricted in the radial direction outward. Thus, if at least a section of the first unit 11 fails mechanically and therefore the testing of the rotor 3 has to be discontinued, the rotor 3 can be captured by the second receiving unit 13 and can be safely braked or run down. This is achieved in particular if the second receiving unit 13 is positioned close to the rotor 3.

In the first embodiment of the test bench 1 according to the invention and the second embodiment of the test bench 1 according to the invention, the contact surface 39 of the first connecting section 21 of the second receiving unit 13 is made to extend completely circumferentially. Since the contact surface 39 of the first connecting section 21 of the second receiving unit 13 extends completely circumferentially, in particular in combination with a completely circumferential contact surface 41 of the rotor 3, particularly robust mechanical protection is provided for the case when at least one section of the first receiving unit 11 fails mechanically. In order to place the rotor 3 on the test bench 1 for the testing of the rotor 3, first the second receiving unit 13 is brought in relative to the rotor 3 in the axial direction in such manner that the contact surface 39 forms a clearance fit with the contact surface 41 of the rotor 3. Thanks to the clearance fit the second receiving unit 13 can be moved relative to the rotor 3 in the axial direction particularly simply. Next, as already described, the first receiving unit 11 and the rotor 3 are brought to the connected condition already described in which the contact surface 27 of the first connecting section 15 of the first receiving unit 11 is connected by friction force to the contact surface 29 of the rotor 3. The clearance fit between the contact surface 39 of the first connecting section 21 of the second receiving unit 13 and the contact surface 41 of the rotor 3 refers to a clearance fit between those two components, so that a relative rotation movement about the rotation axis 5 and a relative axial movement parallel to the rotation axis 5 is ensured by the clearance fit.

In the first and second embodiments of the test bench 1 according to the invention, the second connecting section 23 of the second receiving unit 13 comprises an at least partially circumferential and radially outward-facing contact surface 43. The contact surface 43 is designed such that in a connected condition it forms a press fit with an at least partially circumferential and radially inward-facing contact surface 45 of the second connecting section 17 of the first receiving unit 11, in such manner that at least a part of the clearance fit originally present between second connecting section 17 of the first receiving unit 11 is deformed radially outward so that the at least partially circumferential and radially outward-facing contact surface 33 of the second connecting s 17 of the first receiving unit 11 and the at least partially circumferential and radially inward-facing contact surface 35 of the part 37 of the test bench 1 mounted to rotate about the rotation axis 5 are connected to one another by friction force. The press fit between the contact surface 43 of the second connecting section 23 of the second receiving unit 13 and the contact surface 45 of the second connecting section 17 of the first receiving unit 11 thus results, in the connected condition, in that in the connected condition at least a part of the second connecting section 17 of the first receiving unit 11 is deformed radially outward in such manner that from the clearance fit originally present between the contact surface 33 of the second connecting section 17 of the first receiving unit 11 and the contact surface 35 of the part 37 of the test bench 1 in the installed condition, a frictional connection is formed between the contact surface 33 of the second connecting section 17 of the first receiving unit 11 and the contact surface 35 of the part 37 of the test bench 1. Since the contact surface 43 is designed such that in a connected condition it forms a press fit with an at least partially circumferential and radially inward-facing contact surface 45 of the second connecting section 17 of the first receiving unit 11, in such manner that at least part of the second connecting section 17 of the first receiving unit 11 is deformed radially outward, and such that the at least partially circumferential and radially outward-facing contact surface 33 of the second connecting section 17 of the first receiving unit 11 and the at least partially circumferential and radially inward-facing contact surface 35 of the part 37 of the test bench 1 mounted rotatably about the rotation axis 5 are frictionally connected with one another, it is ensured that the first receiving unit 11, with the help of the second receiving unit 13, can be centered particularly precisely, in particular relative to the rotation axis 5, which can also be called exact centering of the first receiving unit 11. Since with the help of the second receiving unit 13 the first receiving unit 11 is centered particularly precisely, the first receiving unit 11 constitutes a particularly precisely centered section with which a section of the rotor 3 can be connected directly or indirectly by way of a further component such as the second receiving unit 13 or a plurality of further components, so that the rotor 3 too is particularly precisely centered. As already described, in the first embodiment of the test bench 1 according to the invention and in the second embodiment of the test bench 1 according to the invention, the first connecting section 15 of the first receiving unit 11 comprises the at least partially circumferential and radially inward-facing contact surface 27, which is designed such that in a connected condition it can be frictionally connected to an at least partially circumferential and radially outward-facing contact surface 29 of the rotor 3, and this in the connected condition, so that both in the first and in the second embodiment of the test bench 1 according to the invention the frictional connection is ensured by means of an interference fit. Thus, if now the first receiving unit 11 is already connected to the rotor 3 and in that connected condition, with the help of the second receiving unit 13, it is centered particularly precisely relative to the rotation axis 5, then the rotor 3 too is centered particularly precisely relative to the rotation axis 5, so that the rotor 3 can be tested while particularly precisely centered. Thus, with the help of the receiving system 9 it is ensured that misalignments are avoided or at least that they can be kept particularly slight.

Furthermore, the second connecting section 17 of the first receiving unit 11 comprises a contact surface 49 which extends in the axial direction and is arranged on a first side 47 of the first receiving unit 11, facing in the direction of the first side 47. In addition, the first connecting section 15 of the first receiving unit 11 comprises a contact surface 53 which extends in the axial direction and is arranged on a second side 51 of the first receiving unit 11 opposite the first side 47, facing in the direction of the second side 51. Since the second connecting section 17 of the first receiving unit 11 comprises the contact surface 49 which extends in the axial direction and is arranged on the first side 47 of the first receiving unit 11, facing in the direction of the first side 47, and since the first connecting section 15 of the first receiving unit 11 comprises the contact surface 53 that extends in the axial direction and is arranged on the second side 51 of the first receiving unit 11 opposite the first side 47, facing in the direction of the second side 51, the first receiving unit 11 with the contact surface 49 can be in contact with a contact surface of the part 37 of the test bench 1 that extends in the axial direction and faces in the direction of the second side 51 and, with the contact surface 53, can be in contact with a contact surface of the rotor 3 that extends in the axial direction and faces in the direction of the first side 47, so that the rotor 3 can be held by the test bench 1 without play in the axial direction. By virtue of the contact surfaces described here, due to an elastic deformability of the intermediate section 19 of the first receiving unit 11 to be described later and due to the already described connections between the rotor 3, the first receiving unit 11, the second receiving unit 13 and the part 37 of the test bench 1, it is ensured that the receiving system 9 holds the rotor 3 in a play-free and elastic manner with torque transmission for the rotor 3, which can also be called an E-mobility rotor.

As already described, the circumferential intermediate section 19 of the first receiving unit 11 extends from the first connecting section 15 to the second connecting section 17. Since the circumferential intermediate section 19 of the first receiving unit 11 extends from the first connecting section 15 to the second connecting section 17, the intermediate section 19 can be deformed elastically in such manner that when the intermediate section 19 is in an elastically deformed condition in which the intermediate section 19 is elastically deformed, the first connecting section 15 and/or the second connecting section 17 is/are arranged offset relative to the case when the intermediate section 19 is not elastically deformed. The elastic deformation of the intermediate section 19 is such that due to the elastic deformation of the intermediate section 19 in the axial direction, the first connecting section 15 and/or the second connecting section 17 can adopt a different position, so ensuring that an axial length variation of the rotor 3 can be compensated with the help of the elastic deformation of the intermediate section 19, in the sense that the rotor 3, even after an axial length variation, can still be centered precisely. In particular, in that way precisely centered mounting of the rotor 3 can be ensured even with temperature variations, for example of 200°. Owing to the ability of the intermediate section 19 to deform elastically, the receiving system 9 can also be called an elastic receiving system 9 or an elastic receiver, since during operation, i.e., while testing the rotor 3, any thermal loads and/or length variations that occur can be elastically compensated. During this, depending on the temperature range to be examined and depending on the rotor 3 to be tested, the extension of the intermediate section 19 in the axial direction in the elastically undeformed condition, i.e., the thickness of the intermediate section 19, can be adapted appropriately, so that the elastic deformability of the intermediate section 19 matches the corresponding length variation of the rotor 3 in the axial direction. The extension of the intermediate section 19 in the axial direction in the elastically undeformed condition, i.e., the thickness of the intermediate section 19, is both smaller than the extension of the first connecting section 15 of the first receiving unit 11 in the axial direction and also smaller than the extension of the second connecting section 17 of the first receiving unit 11 in the axial direction, so that both a mechanically robust connection between the first receiving unit 11 and the rotor 3 and a mechanically robust connection between the first receiving unit 11 and the part 37 of the test bench 1 are ensured, as also is sufficient elastic deformability of the intermediate section 19, and all this with a sparing use of materials, so that the receiving system 9 is constructed in a particularly material-saving and compact manner. The intermediate section 19 extends all round the rotation axis 5 and in this case extends along a plane arranged perpendicularly to the rotation axis 5. Since the intermediate section 19 extends all round the rotation axis 5 and along a plane perpendicular to the rotation axis 5, it is ensured that the first receiving unit 11 has high radial rigidity. The radial rigidity of the first receiving unit 11 is uniform in the radial direction. The high radial rigidity of the first receiving unit 11, and in particular its uniformity in the radial direction, has a particularly positive effect on the running of the rotor 3, which due to that is particularly uniform. In addition, owing to the high radial rigidity of the first receiving unit 11, and in particular its uniformity in the radial direction, the bend-critical rotation speed can be substantially increased. In this context the bend-critical rotation speed is understood to mean the rotation speed at which the forces of a defined imbalance excite the rotor 3 and/or the test bench 1 into resonance vibrations.

Furthermore, the first receiving unit 11 comprises a plurality of bores arranged on a circumference of a circle positioned concentrically with the contact surface 33 of the second connecting section 17 of the first receiving unit 11, such that in the assembled condition each bore 55 extends parallel to the rotation axis 5. In addition, the second receiving unit 13 comprises a plurality of bores arranged on a circumference of a circle positioned concentrically with the contact surface 43 of the second connecting section 23 of the second receiving unit 13, such that in the assembled condition each bore 55 extends parallel to the rotation axis 5. With the help of the bores and appropriate fixing means, in this case provided for example in the form of screws, wherein each screw 57 is assigned to a corresponding bore 55 in the first receiving unit 11 and to a corresponding bore 55 in the second receiving unit 13, the second receiving unit 13 and the first receiving unit 11 can be connected to one another so that the second receiving unit 13 is positioned relative to the first receiving unit 11 in such manner that the second connecting section 23 of the second receiving unit 13 elastically deforms the second connecting section 17 of the first receiving unit 11 radially outward and thereby produces in the second connecting section 17 of the first receiving unit 11, at least in part, the elastically deformed condition already described.

Moreover, the second receiving unit 13 comprises a plurality of balancing bores arranged on a circumference of a circle which is also positioned concentrically with the contact surface 43 of the second connecting section 23 of the second receiving unit 13, wherein each balancing bore 59, in the assembled condition, extends parallel to the rotation axis 5. Each balancing bore 59 is provided with an internal thread. To balance the rotor 3 or the part of the rotor 3 that rotates about the rotation axis 5 during the testing of the rotor 3, i.e., to reduce or eliminate any imbalance of the rotor 3 or of the part of the rotor 3 that rotates about the rotation axis 5 during the testing of the rotor 3, a corresponding threaded pin that can also be called a headless screw can be screwed into each balancing bore.

In addition, the second receiving unit 13 comprises a plurality of forcing bores arranged on a circumference of a circle which is again positioned concentrically with the contact surface 43 of the second connecting section 23 of the second receiving unit 13, wherein each forcing bore 61, in the assembled condition, extends parallel to the rotation axis 5. Each forcing bore 61 is provided with an internal thread. To dismantle the second receiving unit 13 from the first receiving unit 11, screws are inserted into the forcing bores, which screws then come into contact at their end against the first receiving unit 11 and by being screwed farther into the thread push the second receiving unit 13 away from the first receiving unit 11. This greatly simplifies the dismantling of the first receiving unit 11 from the second receiving unit 13. All-in-all, with the help of the receiving system 9 high torques can be transmitted to the rotor 3 to be tested and high rotation speeds of the rotation of the rotor 3 produced.

As already described, FIG. 13 shows a schematic representation of a section of a third embodiment of the test bench 1 according to the invention, and FIGS. 14 and 15 show, respectively, schematic representations of a corresponding section of a fourth embodiment of the test bench 1 according to the invention.

In the third embodiment of the test bench 1 according to the invention, represented schematically in FIG. 13, the receiving system 9 is essentially made identically to the receiving system 9 of the first embodiment of the test bench 1 according to the invention and to the receiving system of the second embodiment of the test bench 1 according to the invention. In addition to the first receiving unit 11 and the second receiving unit 13, the receiving system 9 comprises a clamping ring 63. In the assembled condition, the clamping ring 63 extends around the rotation axis 5. The clamping ring 63 is configured such that in the assembled condition it is arranged around part of the first connecting section 15 of the first receiving unit 11. The clamping ring 63 has a circumferential and radially inward-facing contact surface, which is in contact with a circumferential and radially outward-facing contact surface of the part of the first connecting section 15 of the first receiving unit 11, in such manner that at least the part of the first connecting section 15 of the first receiving unit 11 is elastically deformed radially inward and between the contact surface 27 of the first connecting section 15 of the first receiving unit 11 and the contact surface 29 of the rotor 3, a frictional connection is produced. This frictional connection, which is produced with the help of the clamping ring 63, is an alternative to the already-described interference fit and can also be called a clamped connection. The advantage of the clamped connection, in particular compared with the interference fit, is that with the clamped connection the assembly and dismantling of the components to be joined is substantially simpler and hereby, in particular, the matching surfaces of these components are not damaged while connecting and releasing them, or are only slightly loaded mechanically.

In the fourth embodiment of the test bench 1 according to the invention, represented schematically in FIGS. 14 and 15, the receiving system 9 is essentially configured identically to the receiving system 9 of the first embodiment of the test bench 1 according to the invention and to the second embodiment of the test bench 1 according to the invention.

In the fourth embodiment of the test bench 1 according to the invention, the first connecting section 15 of the first receiving unit 11, in a connected condition, is connected to a part 37 of the test bench 1 mounted rotatably about the rotation axis 5. Since the first connecting section 15 of the first receiving unit 11 in a connected condition is connected to a part 37 of the test bench 1 which is mounted to rotate about the rotation axis 5, it is ensured that with the help of the first receiving unit 11 the rotor 3 can be mounted rotatably on a frame 7 of the test bench 1.

Furthermore, in the fourth embodiment of the test bench 1 according to the invention the first connecting section 21 of the second receiving unit 13 comprises an at least partially circumferential and radially inward-facing contact surface 39, which is designed such that in a connected condition it can be connected by friction-force to an at least partially circumferential and radially outward-facing contact surface 41 of the rotor 3, and in the connected condition it is so connected by friction force. In the fourth embodiment of the test bench 1 according to the invention the frictional connection is ensured with the help of an interference fit. The interference fit is made in such manner that before the frictional connection of the contact surface 39 of the first connecting section 21 of the second receiving unit 13 and the contact surface 41 of the rotor 3, the second receiving unit 13 is heated, at least in part, whereby the contact surface 39 of the first connecting section 21 of the second receiving unit 13 expands outward in the radial direction so that for the connection of the contact surface 39 of the first connecting section 21 of the second receiving unit 13 and the contact surface 41 of the rotor 3, in the axial direction, no force, or only a much smaller force has to be applied than is the case in the situation where, before the frictional connection of the contact surface 39 of the first connecting section 21 of the second receiving unit 13 and the contact surface 41 of the rotor 3 the second receiving unit 13 is not heated. The contact surface 39 of the first connecting section 21 of the second receiving unit 13 and the contact surface 41 of the rotor 3 are now connected to one another in the axial direction and the at least partial heating of the second receiving unit 13 is discontinued, so that during the subsequent temperature equalization pressure is produced and the interference fit is produced thereby. During the process the surface roughness of the contact surface 39 of the first connecting section 21 of the second receiving unit 13 and the surface roughness of the contact surface 41 of the rotor 3 are both to a large extent maintained, whereby a mechanically particularly robust seating is achieved.

In the fourth embodiment of the test bench 1 according to the invention, the contact surface 39 of the first connecting section 21 of the second receiving unit 13 is made completely circumferential. Since the contact surface 39 of the first connecting section 21 of the second receiving unit 13 is made completely circumferentially, particularly in combination with a completely circumferential contact surface 41 of the rotor 3, a particularly robust mechanical connection is formed between the second receiving unit 13 and the rotor 3. When the rotor 3 is fitted onto the test bench 1 for testing, the second receiving unit 13 and the rotor 3 are in a connected condition in which the contact surface 39 of the first connecting section 21 of the second receiving unit 13 and the contact surface 41 of the rotor 3 are connected by friction force. The frictional connection between the contact surface 39 of the first connecting section 21 of the second receiving unit 13 and the contact surface 41 of the rotor 3 ensures that torque can be transmitted from the rotor 3 to the second receiving unit 13 and/or from the second receiving unit 13 to the rotor 3. The frictional connection between the contact surface 39 of the first connecting section 21 of the second receiving unit 13 and the contact surface 41 of the rotor 3 relates to a friction-force lock between those two components that opposes a relative rotation about the rotation axis 5.

In the fourth embodiment of the test bench 1 according to the invention, the receiving system 9 comprises a centering ring 65. In addition, in the fourth embodiment of the test bench 1 according to the invention the second connecting section 17 of the first receiving unit 11 comprises an at least partially circumferential and radially outward-facing contact surface 33. The contact surface 33 is designed such that in an installed condition it forms a clearance fit with an at least partially circumferential and radially inward-facing contact surface 67 of the centering ring 65. Since a clearance fit is formed between the contact surface 33 of the second connecting section 17 of the first receiving unit 11 and the contact surface 67 of the centering ring 65, it is ensured that the first receiving unit 11 can be fitted particularly simply on the centering ring 65, and for that reason the receiving system 9 can also be said to be particularly assembly-friendly.

In the fourth embodiment of the test bench 1 according to the invention, the contact surface 33 of the second connecting section 17 of the first receiving unit 11 is made completely circumferential. Since the contact surface 33 of the second connecting section 17 of the first receiving unit 11 is made completely circumferentially, particularly in combination with a completely circumferential contact surface 67 of the centering ring 65 a mechanically particularly robust connection is formed between the first receiving unit 11 and the centering ring 65, and more will be said later about this connection between the first receiving unit 11 and the centering ring 65. To fit the rotor 3 into the test bench 1 for the testing of the rotor 3, first the second receiving unit 13 and the rotor 3 are brought to the already described connected condition in which the contact surface 39 of the first connecting section 21 of the second receiving unit 13 is frictionally connected to the contact surface 41 of the rotor 3. The first receiving unit 11 is already fixed onto the part 37 of the test bench 1 and is in an installed condition in which the contact surface 33 forms a clearance fit with the at least partially circumferential and radially inward-facing contact surface 67 of the centering ring 65. Thanks to the clearance fit, the first receiving unit 11 can be brought particularly simply to the installed condition. Preferably, the second connecting section 17 of the first receiving unit 11 is in an undeformed condition, in particular in an elastically undeformed condition. The clearance fit between the contact surface 33 of the second connecting section 17 of the first receiving unit 11 and the contact surface 67 of the centering ring 65 refers to a clearance fit between these two components, so that a relative rotation movement about the rotation axis 5 is ensured by the clearance fit.

In the fourth embodiment of the test bench 1 according to the invention, the second connecting section 23 of the second receiving unit 13 comprises an at least partially circumferential and radially outward-facing contact surface 43. The contact surface 43 is designed such that in a connected condition it forms a press fit with an at least partially circumferential and radially inward-facing contact surface 45 of the second connecting section 17 of the first receiving unit 11, in such manner that at least part of the second connecting section 17 of the first receiving unit 11 is deformed radially outward so that the at least partially circumferential and radially outward-facing contact surface 33 of the second connecting section 17 of the first receiving unit 11 and the at least partially circumferential and radially inward-facing contact surface 67 of the centering ring 65 are frictionally connected with one another. Thus, in the connected condition the press fit between the contact surface 43 of the second connecting section 23 of the second receiving unit 13 and the contact surface 45 of the second connecting section 17 of the first receiving unit 11 has the result that in the connected condition at least part of the second connecting section 17 of the first receiving unit 11 is deformed radially outward in such manner that from the clearance fit originally present in the installed condition between the contact surface 33 of the second connecting section 17 of the first receiving unit 11 and the contact surface 67 of the centering ring 65 a friction-force connection is formed between the contact surface 33 of the second connecting section 17 of the first receiving unit 11 and the contact surface 67 of the centering ring 65. Since the contact surface 43 is designed such that in a connected condition it forms with an at least partially circumferential and radially inward-facing contact surface 45 of the second connecting section 17 of the first receiving unit 11 a press fit in such manner that at least part of the second connecting section 17 of the first receiving unit 11 is deformed radially outward, so that the at least partially circumferential and radially outward-facing contact surface 33 of the second connecting section 17 of the first receiving unit 11 and the at least partially circumferential and radially inward-facing contact surface 67 of the centering ring 65 are frictionally connected with one another, it is ensured that the first receiving unit 11, with the help of the second receiving unit 13, can be centered particularly precisely in particular relative to the rotation axis 5, which can also be called an exact centering of the first receiving unit 11. Since with the help of the second receiving unit 13 the first receiving unit 11 is centered particularly precisely, the first receiving unit 11 provides a particularly precisely centered section with which the rotor 3 can be connected directly, or indirectly by way of a further component such as the second receiving unit 13, or a plurality of further components, so that the rotor 3 too is particularly precisely centered. As already described, in the fourth embodiment of the test bench 1 according to the invention the first connecting section 21 of the second receiving unit 13 comprises the at least partially circumferential and radially inward-facing contact surface 39, which is designed such that in a connected condition it can be frictionally connected with the at least partially circumferential and radially outward-facing contact surface 41 of the rotor 3, and in the connected condition this is so, such that in the fourth embodiment of the test bench 1 according to the invention the frictional connection is ensured by means of an interference fit. If now, therefore, the second receiving unit 13 is already connected to the rotor 3 and in the connected condition the first receiving unit 11, with the help of the second receiving unit 13, is centered particularly precisely especially relative to the rotation axis 5, then the second receiving unit 13 too and the rotor 3 as well are centered particularly precisely especially relative to the rotation axis 5, so that the rotor 3 can be tested when it is centered particularly precisely. Thus, with the help of the receiving system 9 it is ensured that misalignments can be avoided or at least kept particularly slight.

Furthermore, the second connecting section 23 of the second receiving unit 13 comprises a contact surface 71 arranged in the axial direction on a first side 69 of the second receiving unit 13 and facing in the direction of the first side 69. In addition, the first connecting section 21 of the second receiving unit 13 comprises a contact surface 75 arranged in the axial direction on a second side 73 of the second receiving unit 13 opposite the first side 69 and facing in the direction of the second side 73. Since the second connecting section 23 of the second receiving unit 13 comprises the contact surface 71 that extends in the axial direction and is arranged on the first side 69 of the second receiving unit 13, facing in the direction toward the first side 69, and since the first connecting section 21 of the second receiving unit 13 comprises the contact surface 75 which extends in the axial direction and is arranged on the second side 73 opposite the first side 69 of the second receiving unit 13 and faces in the direction toward the second side 73, the second receiving unit 13 can make contact with the contact surface 71 over a contact surface of the second connecting section 17 of the first receiving unit 11 which extends in the axial direction and faces toward the second side 73, and make contact also with the contact surface 75 over a contact surface of the rotor 3 that extends in the axial direction and faces in the direction toward the first side 69, so that the rotor 3 can be held in the axial direction without play. Thanks to the contact surfaces described here, to the elastic deformability of the intermediate section 19 of the first receiving unit 11 and to the already-described connections between the rotor 3, the second receiving unit 13, the first receiving unit 11 and the part 37 of the test bench 1, it is ensured that the receiving system 9 can hold the rotor 3 without play and in an elastic manner and transmit torque to it, this also being referred to as an E-mobility rotor.

As already described, the circumferential intermediate section 19 of the first receiving unit 11 extends from the first connecting section 15 to the second connecting section 17. Since the circumferential intermediate section 19 of the first receiving unit 11 extends from the first connecting section 15 to the second connecting section 17, the intermediate section 19 can be deformed elastically in such manner that the first connecting section 15 and/or the second connecting section 17, when the intermediate section 19 is in an elastically deformed condition in which the intermediate section 19 is elastically deformed, is/are offset in the axial direction compared with the case when the intermediate section 19 is in an elastically undeformed condition. Owing to the elastic deformation of the intermediate section 19 in such manner that the first connecting section 15 and/or the second connecting section 17 can adopt a different position due to the elastic deformation of the intermediate section 19 in the axial direction, it is ensured that an axial length variation of the rotor 3 can be compensated with the help of the elastic deformation of the intermediate section 19, in the sense that even after an axial length variation the rotor 3 is still mounted in a precisely centered manner. In particular, in that way the precisely centered mounting of the rotor3 can be ensured even if the temperature changes, for example by 200° C. Thanks to the possibility of deforming the intermediate section 19 elastically, the receiving system 9 can also be called an elastic receiving system 9 or an elastic receiver, since during operation, i.e., when the rotor 3 is being tested, thermal loads and/or length expansions can be compensated elastically. In that case, the extension of the intermediate section 19 in the elastically deformed condition in the axial direction, i.e., the thickness of the intermediate section 19, can be adapted correspondingly as a function of the temperature range to be examined and as a function of the rotor 3 to be tested, so that the elastic deformability of the intermediate section 19 is matched to the corresponding length variation of the rotor 3 in the axial direction. The extension of the intermediate section 19 in the axial direction in its elastically undeformed condition, i.e., the thickness of the intermediate section 19, is both smaller than the extension of the first connecting section 15 of the first receiving unit 11 in the axial direction and also smaller than the extension of the second connecting section 17 of the first receiving unit 11 in the axial direction, so that both a mechanically robust connection between the first receiving unit 11 and the part 37 of the test bench 1 and also a mechanically robust connection between the first receiving unit 11, the centering ring 65 and the second receiving unit 13 are ensured, as also is a sufficient elastic deformability of the intermediate section 19, and this is ensured even with a sparing use of materials so that the receiving system 9 is made in a particularly material-saving manner and is compact. The intermediate section 19 extends circumferentially about the rotation axis 5 and extends along a plane arranged perpendicularly to the rotation axis 5. Since the intermediate section 19 extends circumferentially about the rotation axis 5 and extends along a plane arranged perpendicularly to the rotation axis 5, it is ensured that the first receiving unit 11 has high radial rigidity. The radial rigidity of the first receiving unit 11 is uniform. The high radial rigidity of the first receiving unit 11 and in particular the uniform rigidity of the first receiving unit 11 in the radial direction has a particularly positive effect on the running of the rotor 3, which for that reason is particularly even. Furthermore, the high radial rigidity of the first receiving unit 11 and in particular the uniform rigidity of the first receiving unit 11 in the radial direction can substantially increase the bend-critical rotation speed. In this context the bend-critical rotation speed can be regarded as the rotation speed at which the forces of a defined rotating imbalance excite the rotor 3 and/or the test bench 1 into resonance vibrations. All in all, with the help of the receiving system 9 high torques can be transmitted to the rotor 3 being tested and high rotation speeds of the rotation of the rotor 3 can be achieved.

In the example embodiments of the test bench 1 illustrated, the test bench 1 has two receiving systems, each of the receiving systems corresponding to the receiving system 9 described in connection with the corresponding example embodiment of the test bench 9 illustrated and described. Since the test bench 1 comprises two receiving systems, with the help of the receiving system 9 particularly high torques can be transmitted to the rotor 3 being tested and particularly high rotation speeds of the rotation of the rotor 3 can be achieved.

In connection with the present invention the term “radial direction” is used. Here, the radial direction preferably refers to an assembled condition in which the rotor 3 is fitted onto the test bench 1 in order to be tested. Moreover, the radial direction preferably relates to the rotation axis 5 and preferably describes a direction which, in a plane arranged perpendicularly to the rotation axis 5, extends away from the rotation axis 5 (radially outward) or toward the rotation axis 5 (radially inward). Furthermore, in connection with the present invention the term “axial direction” is used. The axial direction preferably refers to an assembled condition in which the rotor 3 is fitted onto the test bench 1 in order to be tested. Moreover, the axial direction preferably relates to the rotation axis 5 and preferably describes a direction parallel to the rotation axis 5. In addition, in connection with the present invention the term “circumferential” is used. Here, circumferential preferably refers to an assembled condition in which the rotor 3 is fitted onto the test bench 1 in order to be tested. Moreover “circumferential” preferably relates to the rotation axis 5 and preferably describes an arrangement or structure that surrounds the rotation axis 5. Furthermore, in connection with the present invention connected conditions and installed conditions and similar conditions are referred to in which, in each case, preferably the components directly involved are in the corresponding condition. For example, when a first component and a second component are in a connected condition, then the first and second components are connected to one another. And, for example, when a first component is in an installed condition in connection with a second component, then the first component is installed in the second component and the first component and the second component are preferably at first not connected with one another around the rotation axis 5.

A further aspect of the present invention is the already described first receiving unit 11 for the receiving system. The already described features, technical effects and/or advantages also apply, when this has not been explicitly described, at least in an analogous manner to the first receiving unit 11. Thus, the first receiving unit 11 comprises the circumferential first connecting section 15, the circumferential second connecting section 17 and the circumferential intermediate section 19 that extends from the first connecting section 15 to the second connecting section 17. A further aspect of the present invention is the already described second receiving unit 13 for the receiving system 9. The already described features, technical effects and/or advantages also apply, when this has not been explicitly described, at least in an analogous manner to the second receiving unit 13. Thus, the second receiving unit 13 comprises the circumferential first connecting section 21, the circumferential second connecting section 23 and the circumferential intermediate section 25 that extends from the first connecting section 21 to the second connecting section 23.

Additionally, it should be pointed out that “facing” does not exclude any other elements or steps and “a” or “one” does not exclude a plurality. Furthermore, it should be pointed out that features that have been described with reference to one of the above example embodiments can also be used in combination with other example embodiments described above. Indexes in the claims should not be regarded as limitations.

### INDEXES

1 Test bench
3 Rotor
5 Rotation axis
7 Frame of the test bench
9 Receiving system
11 First receiving unit
13 Second receiving unit
15 First connecting section of the first receiving unit
17 Second connecting section of the first receiving unit
19 Intermediate section of the first receiving unit
21 First connecting section of the second receiving unit
23 Second connecting section of the second receiving unit
25 Intermediate section of the second receiving unit
27 Contact surface of the first connecting section of the first receiving unit
29 Contact surface of the rotor
31 Groove
33 Contact surface of the second connecting section of the first receiving unit
35 Contact surface of part of the test bench
37 Part of the test bench
39 Contact surface of the first connecting section of the second receiving unit
41 Contact surface of the rotor
43 Contact surface of the second connecting section of the second receiving unit
45 Contact surface of the second connecting section of the first receiving unit
47 First side of the first receiving unit
49 Contact surface of the second connecting section of the first receiving unit
51 Second side of the first receiving unit
53 Contact surface of the first connecting section of the first receiving unit
55 Bore
57 Screw
59 Balancing bore
61 Forcing bore
63 Clamp ring
65 Centering ring
67 Contact surface of the centering ring
69 First side of the second receiving unit
71 Contact surface of the second connecting section of the second receiving unit
73 Second side of the second receiving unit
75 Contact surface of the first connecting section of the second receiving unit

1. A receiving system (9) for a device for receiving a unit, wherein the unit, in an installed condition, is mounted on a device and can rotate about a rotation axis (5) on a frame (7) of the device, the receiving system (9) comprising:
a first receiving unit (11) and a second receiving unit (13), wherein the first receiving unit (11) comprises a first circumferential connecting section (15), a second circumferential connecting section (17), and a circumferential intermediate section (19) that extends from the first connecting section (15) to the second connecting section (17), and wherein the second receiving unit (13) comprises a first circumferential connecting section (21), a second circumferential connecting section (23), and a circumferential intermediate section (25) that extends from the first connecting section (21) to the second connecting section (23);
wherein the second connecting section (17) of the first receiving unit (11) comprises an at least partially circumferential and radially outward-facing contact surface (33) configured such that in an installed condition it forms a clearance fit with an at least partially circumferential and radially inward-facing contact surface of the device; and
wherein the second connecting section (23) of the second unit (13) comprises an at least partially circumferential and radially outward-facing contact surface configured such that in an installed condition it forms a press fit with an at least partially circumferential and radially inward-facing contact surface (45) of the second connecting section (17) of the first receiving unit (11) in such manner that at least part of the second connecting section (17) of the first receiving unit (11) is deformed radially outward so that the at least partially circumferential and radially outward-facing contact surface (33) of the second connecting section (17) of the first receiving unit (11) is frictionally connected to the at least partially circumferential and radially inward-facing contact surface of the device.

2. The receiving system (9) according to claim 1, wherein the first connecting section (15) of the first receiving unit (11) comprises an at least partially circumferential and radially inward-facing contact surface (27) configured such that in a connected condition it can be connected by friction force to an at least partially circumferential and radially outward-facing contact surface (29) of the unit.

3. The receiving system (9) according to claim 1, wherein the first connecting section (21) of the second receiving unit (13) comprises an at least partially circumferential and radially inward-facing contact surface (39) configured such that in a connected condition it forms a clearance fit with an at least partially circumferential and radially outward-facing contact surface (41) of the unit.

4. The receiving system (9) according to claim 1, wherein the first connecting section (5) of the first receiving unit (11) comprises an at least partially circumferential groove (31) which is open radially outward.

5. The receiving system (9) according to claim 1, wherein in a connected condition, the first connecting section (15) of the first receiving unit (11) is connected to a part (37) of the device that is mounted so as to rotate about the rotation axis (5).

6. The receiving system (9) according to claim 1, wherein the first connecting section (21) of the second receiving unit (13) comprises an at least partially circumferential and radially inward-facing contact surface (30) configured such that in a connected condition it can be connected by friction force to a partially circumferential and radially outward-facing contact surface (41) of the unit.

7. The receiving system (9) according to claim 1, wherein in the installed condition the at least partially circumferential and radially inward-facing contact surface of the device forms the clearance fit with the at least partially circumferential and radially outward-facing contact surface (33) of the second connecting section (17) of the first receiving unit (11), a contact surface (35) of a part (37) of the device which is mounted so as to rotate about the rotation axis (5) or the receiving system (9) comprises a centering ring which comprises an at least partially circumferential and radially inward-facing contact surface (67), with which surface, in the installed condition, the at least partially circumferential and radially outward-facing contact surface (33) of the second connecting section (17) of the first receiving unit (11) forms the clearance fit.

8. A receiving unit (11) for a receiving system (9) according to claim 1, wherein the receiving unit (11) comprises a circumferential first connecting section (15), a circumferential second connecting section (17), and a circumferential intermediate section (19) that extends from the first connecting section (15) to the second connecting section (17).

9. (canceled)

10. A device for receiving a unit, comprising:
a frame with a rotation axis; and
the receiving system (9) according to claim 1;
wherein in an installed condition the unit is mounted so as to rotate about the rotation axis (5) of the frame (7).
